(19) United States
(12) Patent Application Publication
(10) Pub. No.: US 2025/0354568 A1
(43) Pub. Date: Nov. 20, 2025

(54) COMPRESSED-AIR-DRIVEN VACUUM GENERATION DEVICE AND AREA SUCTION GRIPPER

(71) Applicant: J.Schmalz GmbH, Glatten (DE)

(72) Inventors: Thomas LORENZ, Sinzheim (DE); Fabian SCHNEIDER, Pfalzgrafenweiler (DE); Anne JUNGKURTH, Loßburg (DE)

(73) Assignee: J.Schmalz GmbH, Glatten (DE)

(21) Appl. No.: 19/209,370

(22) Filed: May 15, 2025

(30) Foreign Application Priority Data
May 16, 2024 (DE) 10 2024 113 692.8

(51) Int. Cl. F04F 5/20; F04F 5/46

(52) U.S. Cl. CPC F04F 5/20; F04F 5/467

(57) ABSTRACT

A compressed-air-driven vacuum generation device, in particular for insertion into a housing of an area suction gripper, comprising a plurality of nozzle lines, each with at least one ejector nozzle for generating a vacuum from compressed air, at least one compressed-air connection for connection to a compressed-air supply, a valve device which is designed to individually open and/or close a particular flow connection between the nozzle lines and the at least one compressed-air connection.

The invention relates to a compressed-air-driven vacuum generation device and an area suction gripper.

Such vacuum generation devices and area suction grippers for gripping objects are known. This allows the objects to be suctioned, held in the suctioned state, and moved, to, for example, make them available for a subsequent process step. For example, when suctioning the object, a higher suction power of the vacuum generation device is often required than when holding the object in the suctioned state. Known vacuum generation devices which generate a constant vacuum and therefore a constant suction power, are therefore inefficient in terms of compressed-air supply and energy use.

One way to save energy is to temporarily switch the vacuum generation device on and off. However, this is usually associated with high pressure differences and is not suitable for all materials and pressure ranges, since the suction effect often decreases or increases very quickly. In addition, switching on and off creates relatively high and sudden pressure differences, which, under certain circumstances, greatly strains the object being held.

This method can in particular be problematic for air-permeable, porous objects, since the holding force decreases too quickly upon switching off the vacuum generation devices, which could impair reliability—for example, lead to the object being unintentionally dropped.

The invention is based upon the object, when suctioning and holding objects, of saving energy and compressed air without, as far as possible, compromising reliability.

This object is achieved according to the invention by a compressed-air-driven vacuum generation device having the features of claim 1. The compressed-air-driven vacuum generation device is particularly designed to be inserted into a housing of an area suction gripper. The vacuum generation device has a plurality of nozzle lines, each with at least one ejector nozzle for generating a vacuum from compressed air. Furthermore, the vacuum generation device has at least one compressed-air connection for connection to an in particular external compressed-air supply, as well as a valve device which is designed and preferably configured to open or close a flow connection between the particular nozzle lines, in particular the respective ejector nozzles, and the at least one compressed-air connection. In particular, the design is such that the flow connection can preferably be made selectively to single/individual ejector nozzles, in particular independently of each other in terms of control. This allows individual compressed-air lines to be switched off in order to save energy and/or compressed air coming from a compressed-air reservoir, wherein a vacuum can still be generated by one of the other compressed-air lines so that overall, a sufficient vacuum is generated, in particular to hold an air-permeable or porous object.

The flow connection is understood here in particular to mean a flow connection between the compressed-air connection on the one hand and at least one of the nozzle lines, in particular at least one of the ejector nozzles arranged in the particular nozzle line, on the other. In particular, at least two such particular flow connections are provided, which are preferably connected in parallel to one another in terms of flow, at least partially, and lead to a corresponding number of particular nozzle lines and the ejector nozzles arranged therein.

The nozzle lines can be operated independently of each other, at least to a certain extent. In this case, independent operation and single/individual opening and shutting off is understood to mean in particular that the nozzle lines, with regard to closing and opening, and in particular the relevant technical switching means, can be independently closed and opened in particular with regard to the control of valves. The vacuum generation device is therefore at least structurally designed to close and open a single nozzle line without having to close all the others, and preferably without having to close another nozzle line. It may well be provided, and the valve device accordingly so configured, in particular via a control unit, that a logical dependency exist such that, when opening or blocking one nozzle line, the status of another nozzle line is first checked. This does not contradict the independent or individual opening and blocking of a nozzle line discussed here.

Furthermore, it is possible for a plurality of nozzle lines to be opened and blocked together, provided that there is at least one nozzle line that is not opened and blocked together with the other nozzle lines. Alternatively, all existing nozzle lines can be opened and blocked independently of one another.

The flow ability through the nozzle lines can therefore be individually activated and deactivated. The nozzle lines can be individually opened and blocked, wherein the vacuum generation device is preferably also structurally configured to block and open all the nozzle lines independently of one another, in particular logically independently of one another.

Preferably, the nozzle lines can be supplied with compressed air via the at least one compressed-air connection, in that the compressed air from an in particular external compressed-air supply can flow via the flow connection to the nozzle line and the ejector nozzle.

A nozzle line is understood here in particular to mean a flow section which comprises at least one ejector nozzle and is designed and configured to be able to generate a vacuum from an overpressure, i.e., from compressed air. The nozzle line extends from a nozzle line inlet to a nozzle line outlet, wherein the nozzle line inlet preferably corresponds to an inlet of the first ejector nozzle, in particular the front ejector nozzle in the flow direction, and the nozzle line outlet corresponds to an outlet of the first ejector nozzle or —in particular in the case that the nozzle line has a plurality of ejector nozzles—to an outlet of a downstream, additional, in particular second or third, ejector nozzle. The additional ejector nozzle is arranged in the same nozzle line downstream of the first ejector nozzle in the direction of flow. When flowing through the nozzle line, there is accordingly an initial flow through the first ejector nozzle and then the other, in particular second or third, ejector nozzle.

Preferably, at least two, preferably three, nozzle lines are provided, wherein each of the at least two, preferably three, nozzle lines comprises at least one separate ejector nozzle.

In order to guide the compressed air from the compressed-air connection to the nozzle lines, supplying flow sections are preferably provided which extend from the compressed-air connection to the nozzle lines. Preferably, the supplying flow sections comprise, starting from the compressed-air connection, a common flow section for all nozzle lines and, adjoining it, a plurality of flow branches which preferably branch off from the common flow section in order to supply the compressed air—when the flow connection is open—to the plurality of individual nozzle lines and ejector nozzles.

Alternatively, a plurality of compressed-air connections are preferably provided, wherein the flow branches each extend from the nozzle lines to one of the compressed-air connections.

Preferably, the vacuum generation device has a common compressed-air connection for at least two, preferably all, nozzle lines. Alternatively, the vacuum generation device preferably has a separate compressed-air connection for each of the nozzle lines.

The flow connection is considered to be open in particular if compressed air supplied via the compressed-air connection can flow through it, in particular can flow through in such a way that a vacuum suitable for suctioning and/or holding objects is generated by the ejector nozzle. Correspondingly, it is considered to be closed if there cannot be a flow through the flow connection, or at least cannot be a flow through to the extent necessary for holding and/or suction. This means, for example, that the flow connection can also be opened and blocked by a valve connected downstream in terms of flow.

Preferably, a valve of the valve device is arranged in terms of flow between the nozzle line, in particular the first ejector nozzle of the nozzle line, and the compressed-air connection, in particular in the flow branch leading to the ejector nozzle or in terms of flow downstream of the common flow section.

Alternatively, the valve is arranged in terms of flow downstream of the ejector nozzle assigned to the valve in the same flow branch as the ejector nozzle.

A valve is understood here in particular to mean an actuatable device which is designed and configured to interrupt or open a flow connection upon actuation. Preferably, the valve is designed and configured to interrupt or open exactly one flow branch. Alternatively, the valve is designed and configured to open and/or block a plurality of different flow branches, in particular in different valve positions.

The valve device comprises at least one valve. The valve device is designed and configured such that at least one nozzle line can be closed with the valve, while at least one other nozzle line cannot be closed. A flow through the non-closable nozzle line can be stopped by stopping the compressed-air supply.

In particular, it is possible for a plurality of flow branches and the nozzle lines arranged downstream thereof and the ejector nozzles arranged therein to be blocked and open together with the same valve in one valve position. Furthermore, it is possible that a plurality of flow branches and the corresponding nozzle lines and ejector nozzles cannot be opened or closed.

Preferably, the valve device comprises a plurality of valves and/or one valve, in particular a multi-way valve, wherein the multi-way valve is designed to open and close a plurality of nozzle lines and ejector nozzles, wherein different valve positions are provided for opening and closing individual nozzle lines of the plurality of nozzle lines.

Preferably, each of the nozzle lines, in particular the first, second, and/or third nozzle line, has a flow cross-section which is larger at a first distance from the compressed-air connection than at a second distance, wherein the first distance is smaller than the second distance. Preferably, the flow cross-section in the nozzle line becomes smaller, at least partially, with increasing distance from the compressed-air connection, wherein the flow cross-section is preferably minimal at the flow outlet of the ejector nozzle.

The vacuum generation device can also be designed and configured for suctioning and handling objects.

According to a preferred embodiment of the invention, it is provided that the valve device be designed and configured to block and open a first nozzle line of the plurality of nozzle lines with a first closing element, and to block and open a second and third nozzle line of the plurality of nozzle lines with a second closing element. Preferably, a first and second valve are used as the first and second closing elements. This allows a plurality of vacuum generation stages to be created with only two closing elements, so that the vacuum generation device can be manufactured comparatively easily and inexpensively. In addition, the plurality of vacuum stages make it possible to flexibly adapt the vacuum to the object to be gripped and held.

The flow through the first nozzle line, the second nozzle line, and the third nozzle line can in each case start from the compressed-air connection, preferably via a first, second, and third flow branch. The first, second, and third flow branches branch off from a common flow section which extends between the flow branches and the compressed-air connection.

Preferably, the second and third nozzle lines are blocked with the same actuation of the second closing element, in particular at the same time, and opened with a corresponding additional actuation. For this purpose, it is preferably provided that, in terms of flow, a common flow branch section be arranged between the common flow section and/or the compressed-air connection on the one hand and the second and third nozzle lines on the other, which section connects the second and third nozzle lines, and in particular the second and third flow branches, to the compressed-air connection and in particular to the common flow section.

According to a preferred embodiment of the invention, it is provided that the valve device for opening and blocking the flow connection have at least one control piston, in particular a first control piston and a second control piston. The first control piston in particular serves as a closing element or valve in the sense of this description. The control piston, in particular the first control piston, is preferably arranged in a control piston apparatus and designed and configured to, in terms of flow, block, preferably tightly close, at least one of the nozzle lines, in particular the first nozzle line, and to interrupt or at least weaken the flow connection to the ejector nozzle of this nozzle line. This allows the flow paths to be closed individually so that a vacuum generated by the vacuum generation device can be scaled by adjusting the control piston.

Preferably, the at least one nozzle line, in particular the first nozzle line, is blocked on the inlet side.

The entire control piston apparatus is preferably designed as a control piston module which is structurally separate from the rest of the vacuum generation device. The control piston module can be reversibly separated from other modules of the vacuum generation device, preferably with an easily operable fastening means, and therefore reconnected after separation.

A module is also understood here in particular to mean that the corresponding device is designed as a structural unit, in particular with its own housing.

In particular, the control pistons interrupt a flow connection between at least one of the nozzle lines and the compressed-air connection.

Preferably, the control piston penetrates into the nozzle line and/or the flow branch leading to the nozzle line in order to interrupt the flow connection to the ejector nozzle of this nozzle line. This ensures a tight and reliable closure of the nozzle line.

Preferably, the valve device is designed and configured to block two nozzle lines, in particular the second and third nozzle lines, at once with the second control piston, in particular by blocking the common flow branch section, which is arranged in terms of flow between the compressed-air connection and the nozzle lines.

According to a preferred embodiment of the invention, it is provided that the vacuum generation device for opening and blocking the flow connections have a control apparatus which is designed and configured to actuate the valve device, in particular its closing elements, especially the control pistons, pneumatically and/or electrically, in particular individually and/or completely independently of one another. This simplifies the operation of the valve device and, in particular, enables electrical and/or pneumatic control of the valve device.

For actuating the valve device, the control apparatus preferably comprises control electronics which can be actuated via a control interface and/or follow an internally saved or structurally configured logic in order to actuate the valve device and to open and block the flow connection between the compressed-air connection and the nozzle line or ejector nozzle.

Preferably, the control apparatus is designed to be self-sufficient in such a way that it does not rely on external control signals to open and block the flow connection. Particularly preferably, no control connection from the control apparatus to the outside is provided, wherein the entire required control logic for actuating the valve device is configured in the vacuum generation device itself. This simplifies the installation of the vacuum generation device and makes it versatile to use, since the requirements for external supply infrastructure are reduced.

The control apparatus is further preferably designed and configured to be completely self-sufficient, wherein the control apparatus is preferably designed and configured for completely pneumatic operation, and/or wherein no external electrical supply is provided, in particular no corresponding electrical and/or control connection device is configured.

The control apparatus is preferably designed as a separate control module which is structurally separate from the rest of the vacuum generation device and can be connected thereto, in particular reversibly. The control module can be reversibly separated from other modules of the vacuum generation device, preferably with an easily operable fastening means, and therefore reconnected after separation.

Alternatively, the control apparatus can be integrated into the valve device, a control valve module, and/or the control piston module or another module.

According to a preferred embodiment of the invention, a control valve apparatus is provided which is designed and configured to adjust the control pistons, and for this purpose preferably has at least one electrically and/or pneumatically actuated control valve. The control apparatus is additionally preferably designed and configured to actuate the control valve electrically and/or pneumatically. The control valves on the one hand and the control pistons on the other are preferably arranged in modules that can be separated from each other, in particular the control valve module on the one hand and the control piston module on the other. This means that the control pistons can in particular be actuated automatically, and—given the arrangement in modules that can be separated from each other—individual elements can be replaced individually during maintenance or repair.

Preferably, it is provided that a first control piston be able to be actuated with a first control valve, and a second control piston and a third control piston be able to be actuated jointly with a second control valve.

Alternatively, it is provided that each control piston be assigned its own control valve, wherein the actuation of which allows the particular assigned control piston to be adjusted.

The valve device preferably comprises the control valve apparatus, the control apparatus, and/or the control piston apparatus to open and block the flow connection. Alternatively or additionally, the valve device can have additional valves with which the flow connection can be opened and blocked. In particular, these additional valves can be arranged in the common flow section and/or one or more of the flow branches.

Furthermore, the valve device is preferably controlled by the control apparatus in order to block the flow connection between the compressed-air connection and nozzle line or ejector nozzle, in particular when a current vacuum in a suction volume of a suction body lies below a first threshold value, and to open it in particular when the vacuum generated in the suction volume lies above a second threshold value. The suction volume is, in terms of flow, connected to the ejector nozzle, in particular its vacuum side, and/or to a suction channel to the ejector nozzle so that, during operation of the vacuum generation device and when the flow connection is open, a vacuum is generated in the suction volume by the ejector nozzle in order to suction and hold the object.

A high vacuum—also called strong vacuum—is understood here in particular to mean a nominally low pressure value. A low vacuum—also called a weak vacuum—is understood to mean a correspondingly nominally higher pressure value. At a high vacuum, there is a higher pressure difference from the ambient pressure, in particular the atmospheric pressure, than at a low vacuum. Accordingly it is a higher, i.e., stronger, vacuum if the generated vacuum lies below the first or second threshold value and, correspondingly, a lower, i.e., weaker, vacuum if the generated vacuum is above the first or second threshold value.

It is possible that the first threshold value and the second threshold value are nominally identical.

Preferably, however, the first threshold value differs from the second threshold value, wherein the first threshold value is smaller than the second threshold value, so that the first threshold value corresponds to a stronger vacuum value than the second threshold value. This means that there is a range between the first threshold value and the second threshold value in which no control for opening or blocking nozzle lines takes place.

Pressure sensors are preferably provided to measure the generated vacuum. These are preferably designed and configured to measure a pressure in the suction volume and/or suction channel. The pressure sensors are connectable, in particular connected, to the control apparatus for signal transmission, in particular electronically.

Preferably, the vacuum generation device is designed and configured to block an increasing number of nozzle lines when the currently measured vacuum lies below the first threshold. Therefore, additional nozzle lines are blocked until the measured vacuum rises above the first threshold value. Accordingly, if the measured vacuum lies above the second threshold value, additional nozzle lines are preferably open until the measured vacuum has fallen below the second threshold value.

Particularly preferably, the vacuum generation device is designed and configured to block the first nozzle line in a first blocking step when the measured pressure in the suction volume has fallen below the first threshold value, and preferably to block the second and third nozzle lines in a second blocking step, in particular when the measured pressure continues to be below the first threshold value, and further preferably to block the first, second, and third nozzle lines in a third blocking step, in particular when the measured pressure continues to be below the first threshold value. Preferably, the blocking steps are carried out in this order. Alternatively, however, the first and/or second blocking step can also be skipped, wherein, by means of the second threshold value, it is then checked whether override has occurred and whether individual nozzle lines may need to be opened again.

Furthermore, the vacuum generation device is preferably designed and configured to open the first nozzle line in a first opening step if the measured pressure in the suction volume is measured above the second threshold value, and preferably, in particular if the measured pressure is still above the second threshold value, to open the second and third nozzle lines in a second opening step and preferably to block the first nozzle line, and further preferably, in particular if the measured pressure is still above the second threshold value, to open the first, second, and third nozzle lines in a third opening step. Preferably, the opening steps are carried out in this order. Alternatively however, the first and/or second opening step can also be skipped, wherein, with the aid of the first threshold value, it is then checked whether override has occurred and whether individual nozzle lines may need to be blocked again.

With the help of the blocking and opening steps, it is possible to easily implement a multi-stage pressure control with, in particular, four pressure stages with two closing elements, in particular the first and second control pistons. This allows for a particularly high amount of energy and compressed air to be saved.

According to a preferred embodiment of the invention, it is provided that the vacuum generation device, in particular the ejector nozzle, have at least one suction channel which, in terms of flow, connects a channel suction opening to the nozzle line. Preferably, a plurality of suction channels are provided, wherein each ejector nozzle is assigned its own suction channel. The suction channel opens into the nozzle line and forms a vacuum side so that, during the operation of the vacuum generation device with the nozzle line open, a fluid, in particular air, is suctioned into the nozzle line via the suction channel.

The channel suction opening itself can be designed and configured to grip an object. Furthermore, the suction channel can have the suction volume.

It is preferably provided that the channel suction opening be, in terms of flow, connected to at least one, in particular elastically designed, suction body with a suction chamber which encompasses the suction volume and has a suction opening for gripping the object. It is provided that the suction body, which is in particular elastically designed, come into contact with the object when it is gripped. The at least one suction body is preferably provided by a separately designed housing and/or an adapter piece fastenable to the housing.

According to a preferred embodiment of the invention, it is provided that the ejector nozzles, the suction channel, and the nozzle lines be arranged in a nozzle apparatus designed in particular as a nozzle module. This allows the nozzle module to be easily separated from the rest of the vacuum generation device, which simplifies maintenance and repair measures, for example.

In particular, it is also possible for the nozzle module to have a plurality of sub-modules, wherein, for example, the drive nozzle is arranged in a first sub-module, and a diffuser section of the nozzle line is arranged in a second sub-module.

Overall, the nozzle apparatus is designed and configured to receive compressed air via an inlet of the nozzle line so that the compressed air flows through the drive nozzle, then flows past the mouth region with the suction channel, and then flows in particular via the diffuser section to the flow outlet.

According to a preferred embodiment of the invention, it is provided that the vacuum generation device have a silencer apparatus, which is preferably designed as a silencer module, wherein the silencer apparatus is arranged in terms of flow downstream of the nozzle lines. This allows compressed air to flow from the nozzle lines into the silencer apparatus, in particular via the diffuser section. The silencer module can be designed in a multi-stage manner such that it comprises a plurality of sub-modules. This leads to reduced operating noise, wherein the extent of the noise reduction can be flexibly adapted to the intended use and/or location of the vacuum generation device thanks to the multi-stage design.

A silencer apparatus is understood here in particular to mean a device which is designed and configured to cause a noise reduction, wherein in particular the noise development due to the discharged flows is reduced—for example, by means of foam.

Preferably, the flow flowing through the nozzle line ends in the silencer apparatus.

The silencer apparatus has flow openings in its outside through which the compressed air flowing through the vacuum generation device can escape to the outside.

According to a preferred embodiment of the invention, it is provided that the vacuum generation device have an interface apparatus, in particular an input module arranged at the end, wherein the compressed-air connection and preferably at least one signal connection, in particular for an electrical signal, is arranged on the input module.

For forwarding input signals which are received externally via the control interface and/or for reading out measured values and/or diagnostic data, signal lines can also be provided which can extend in particular from the interface apparatus via the control valve apparatus to the control piston apparatus. As a result, the signals received via the in particular terminal interface apparatus can be forwarded to the control valves and control pistons for their control, wherein the control piston apparatus and the control valve apparatus do not have to be designed to be directly accessible from the outside.

Preferably, the electronics required to open and block the nozzle lines are at least partially, preferably completely, integrated into the vacuum generation device. Consequently, no external control units and/or control signals are required.

The signal lines are connected on the one hand to the control apparatus and on the other to the valve device, in particular the control valves, as well as the pressure sensors for measuring the vacuum in the suction volume and/or suction channels. Preferably, the first threshold value and the second threshold value are saved in the control apparatus—for example, electronically and/or digitally. A pressure value measured by a pressure sensor can be forwarded via the signal lines to the control apparatus in order to be compared there with the first and/or second threshold value and to generate a control signal therefrom. The control signal can then be sent from the control apparatus to the nozzle lines, in particular the first, second, and/or third nozzle line, via the signal lines.

Preferably, all interfaces for contact with external apparatuses, in particular the compressed-air connection and/or signal connection, are arranged on the interface apparatus.

Particularly preferably, the interface apparatus has a cover which cannot be inserted into an external housing for the vacuum generation device and/or is openly accessible at least on one side even in an inserted state. The cover closes the housing when inserted. This protects the other parts of the vacuum generation device within the housing.

Preferably, a compressed-air flow path, which includes the nozzle line and preferably the common flow section as well as the flow branches, extends overall from the compressed-air connection of the interface apparatus, via the control valve apparatus, the control piston apparatus, the nozzle apparatus, and into the silencer apparatus. Preferably, a corresponding channel structure delimiting the compressed-air flow path passes through the interface apparatus, the control apparatus, the control piston apparatus, and the nozzle apparatus and opens into the silencer apparatus.

According to a preferred embodiment of the invention, it is provided that at least two devices selected from the interface apparatus, the control apparatus, the control piston apparatus, the nozzle apparatus, and/or the silencer apparatus each have at least one fastening element, in particular a plug-in connector, for mutually fastening the two devices to one another. Preferably, the plug-in connectors are designed to be clipped together. This allows the modules to be connected to each other easily and quickly, in particular manually, wherein preferably no tools are required therefor.

According to a preferred embodiment of the invention, it is provided that the interface apparatus, the control apparatus, the control piston apparatus, the nozzle apparatus, and/or the silencer apparatus be connected to one another in series and preferably in the mentioned order. This results in a structurally simple design. In addition, such a vacuum generation device can be easily expanded by connecting additional modules, such as nozzle sub-modules and/or silencer sub-modules, in series between or downstream thereof, in particular in the case of a modular design of the apparatuses, in order to increase the functionality and/or intensity of the silencing or vacuum generation.

Preferably, the vacuum generation device has at least one aligned outer surface which extends over a plurality of devices, in particular modules, and has at least two partial surfaces which are aligned with one another, wherein the two partial surfaces are selected from an outer surface of the interface apparatus, an outer surface of the control valve apparatus, an outer surface of the control piston apparatus, an outer surface of the nozzle apparatus, and/or an outer surface of the silencer apparatus. Preferably, in each connection region in which two adjacent devices are connected to one another, in particular plugged together, at least one such aligned outer surface is provided. Particularly preferably, all outer surfaces of two adjacent modules are aligned with each other in the border region to the adjacent module. This makes insertion into the housing easier, avoids edges on the outside, and increases stability.

Each aligned outer surface is preferably arranged at a maximum distance from an insertion direction, in particular a central axis of the vacuum generation device, so that no other outer surface of the two devices—possibly with the exception of the interface apparatus, in particular its cover, and with the exception of the plug-in connectors—is at a greater distance from the insertion direction or central axis.

Particularly preferably, the interface apparatus is connected in particular exclusively to the control apparatus, wherein the control valve apparatus is connected to the control piston apparatus on a side facing away from the interface apparatus, wherein the control piston apparatus is connected to the nozzle apparatus on a side facing away from the control valve apparatus, wherein the nozzle apparatus is connected to the silencer apparatus on a side facing away from the control piston side.

According to a preferred embodiment of the invention, it is provided that at least one non-return device, in particular a non-return valve or a check valve, be arranged in the suction channel to prevent a backflow from the nozzle line, in particular a closed nozzle line, through the channel suction opening to the outside, in particular in the direction of a suction body with a suction volume. This increases the efficiency of the vacuum generation device and avoids energy and compressed air losses.

Preferably, a plurality of non-return devices are assigned to each nozzle line, wherein, in the case of a multi-stage nozzle line, at least one non-return device is preferably assigned to each stage of the nozzle line and is connected thereto in terms of flow.

The non-return device is designed and configured to block the flow connection, in particular in the outward direction through the suction channel, when a threshold differential pressure between internal pressure, in particular in the particular nozzle line, and external pressure, in particular outside the vacuum generation device, is exceeded.

According to an additional preferred embodiment, the vacuum generation device is designed as an insert ejector for an area suction gripper, wherein the vacuum generation device can be inserted into a housing of the area suction gripper, in particular such that, in the inserted state, the module preferably designed as a cover and having the compressed-air outlet, in particular the interface module, protrudes from the housing of the area suction gripper and/or is not completely covered by the housing. Particularly preferably, the control valve module, the control piston module, the nozzle module, and/or the silencer module are arranged, in the inserted state, in the housing in such a way that these modules are not accessible from outside the housing and are in particular completely covered by the housing and possibly other modules and/or components of the vacuum generation device. This provides a compact and robust unit towards the outside.

The object of the invention is also achieved in particular by an area suction gripper with a vacuum generation device according to one of the preceding exemplary embodiments, wherein the area suction gripper has a housing into which the vacuum generation device can be at least partially inserted, in particular pushed in, and preferably removed again. The housing has a plurality of suction openings preferably arranged equidistantly from one another in its suction side, which is preferably provided on an underside. Furthermore, the housing largely surrounds the vacuum generation device, preferably completely, with the exception of the flow outlets of the silencer apparatus, the cover of the interface apparatus, and the duct suction openings. On a suction side, which is arranged in particular on an underside of the housing, on which, in the inserted state, the channel suction openings are arranged, as well as in the region of the flow outlets, corresponding recesses are provided in the housing. The vacuum generation device is inserted into the housing via an insertion opening in the housing. In an inserted state, the insertion opening is preferably completely covered by the interface apparatus, in particular its cover. This means that the vacuum generation device is protected from external influences and can be handled compactly.

The area suction gripper preferably additionally comprises an adapter which is mounted on the underside and distributes the vacuum generated at the channel suction openings over an in particular larger area and/or a particularly larger number of suction openings. The adapter preferably has a plurality of elastic suction bodies which have the suction openings, wherein the suction body is designed and configured to be in contact with the object to be gripped during operation of the vacuum generation device, and in particular to grip it directly.

According to a preferred embodiment of the invention, it is provided that, in the inserted state of the vacuum generation device, the silencer apparatus be arranged completely in an interior space of the housing. This avoids disturbing contours on the outside, which in particular prevents the surface suction cup from getting caught on external structures.

Preferably, the control apparatus, the control piston apparatus, the control valve apparatus, the nozzle apparatus, and/or the interface apparatus are also arranged completely inside the housing. According to an alternative exemplary embodiment, the interface apparatus is only partially arranged in the interior of the housing, wherein in particular a cover of the interface apparatus protrudes at least partially from the housing.

Preferably, a dimension, i.e., a size, in particular the height or width, of the silencer perpendicular to the insertion direction is not greater than that of the remaining modules and/or not greater than the extent of the interior of the housing.

Further details and advantageous embodiments of the invention can be found in the following description, on the basis of which the embodiment of the invention shown in the figures is described and explained in more detail.

In the drawings:

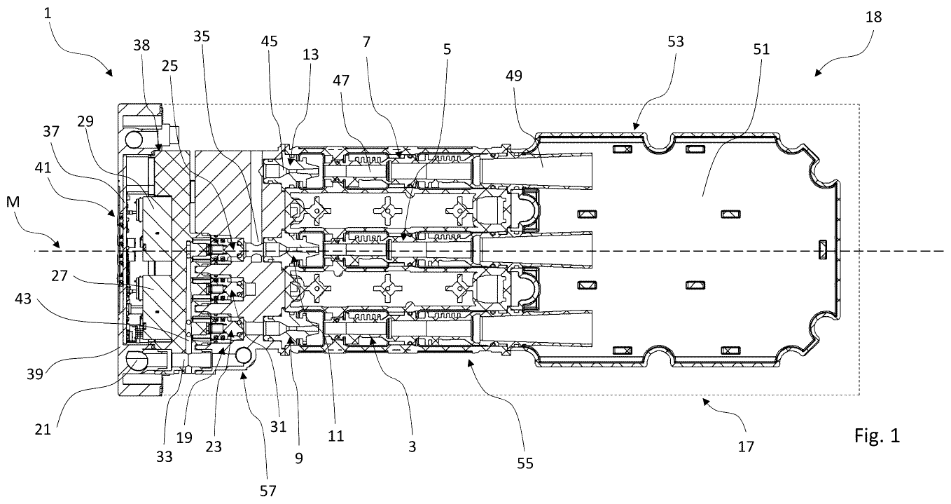

FIG. 1 shows a sectional view of a first embodiment of a vacuum generation device in a view from above;

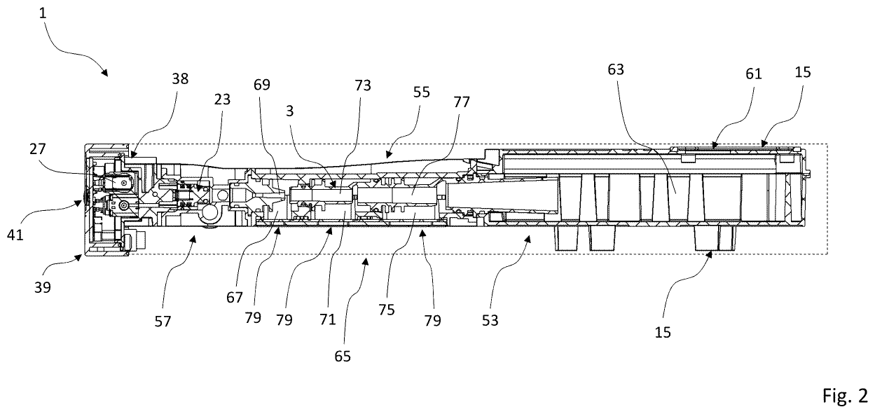

FIG. 2 shows a side sectional view of the first embodiment of the vacuum generation device shown in FIG. 1;

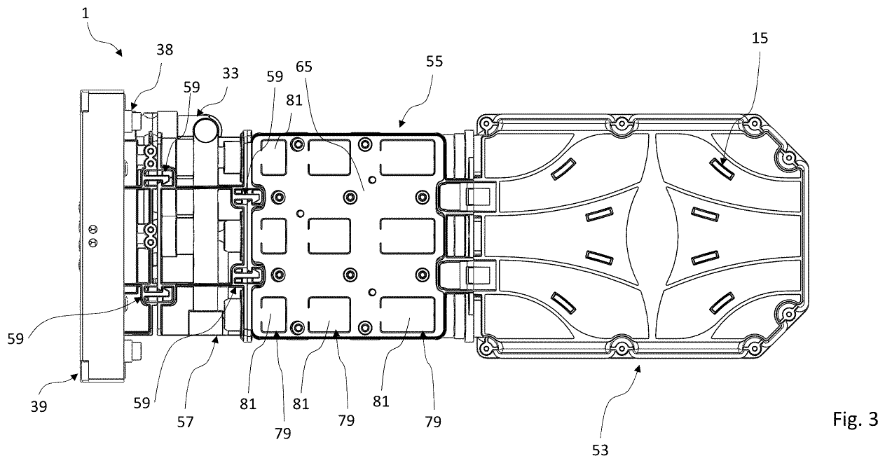

FIG. 3 shows a representation, in a view from below, of the first embodiment of a vacuum generation device shown in FIG. 1;

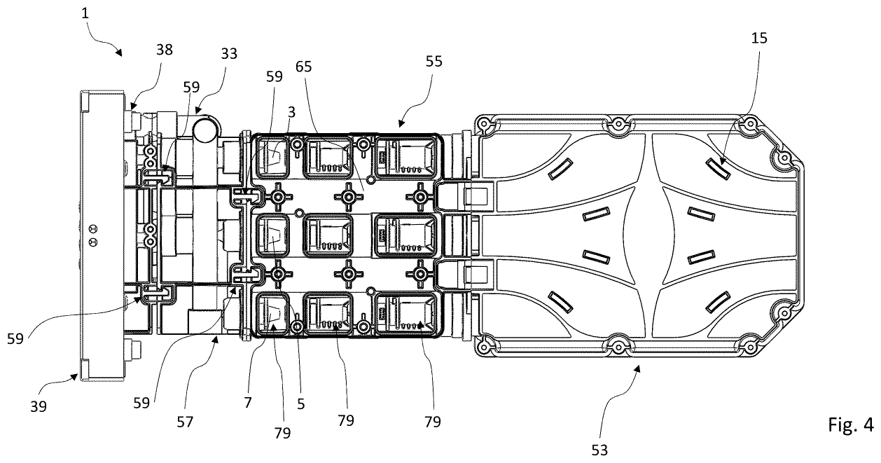

FIG. 4 shows a representation of a second embodiment in a view from below;

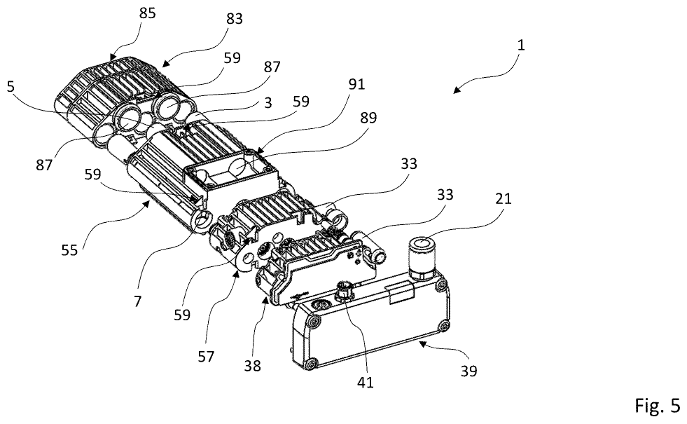

FIG. 5 shows a perspectival view of a vacuum generation device according to a third embodiment;

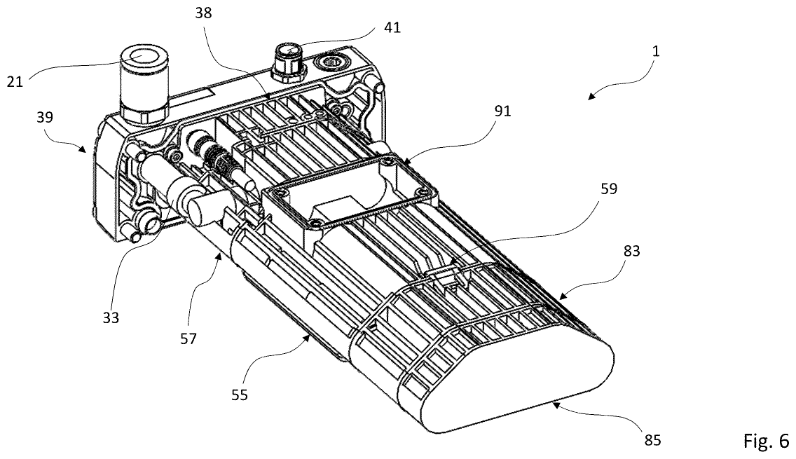

FIG. 6 shows a rotated perspectival view of a vacuum generation device according to the third embodiment.

FIG. 1 shows a vacuum generation device 1 with a plurality of nozzle lines—here in particular a first nozzle line 3, a second nozzle line 5, and a third nozzle line 7. The nozzle lines each have an ejector nozzle—here in particular a first ejector nozzle 9 in the first nozzle line 3, a second ejector nozzle 11 in the second nozzle line 5, and a third ejector nozzle 13 in the third nozzle line 7.

The entire vacuum generation device 1 is designed and configured to be inserted into an external housing 17, which is indicated by dashed lines in FIG. 1 and FIG. 2.

FIG. 1 also shows an area suction gripper 18 which has the vacuum generation device 1 and the housing 17.

Preferably, the vacuum generation device 1 has at least one guide surface 15, which is clearly discernible in FIG. 2. When inserted, the vacuum generation device 1 is supported on the guide surface 15 against an inner wall of the housing and/or a corresponding guide surface of the housing 17.

Furthermore, FIG. 1 shows a central axis M along which the vacuum generation device 1 is inserted into the housing 17, whereby the central axis M simultaneously defines the insertion direction.

The vacuum generation device 1 has a valve device 19 which is designed to individually open and/or block a flow connection between the ejector nozzles and a compressed-air connection 21. In the embodiment shown here, the valve device 19 has in particular control valves and control pistons, wherein the control valves are designed to actuate the control pistons. The control pistons, in turn, are designed and configured to block the flow connection.

In particular, two control pistons are provided, wherein a first control piston 23 is designed and configured to open and block the flow connection to the first nozzle line 3. A second control piston 25 is also designed and configured to open and block the flow connection to the second and third nozzle lines 7.

The first control piston 23 can be actuated via a first control valve 27, while the second control piston 25 can be actuated via a second control valve 29. Upon actuation of the control pistons, they switch between a blocked position and an open position.

In addition, a third control piston 31 is discernible in FIG. 1, which, however, is not designed here to open or block a flow connection to one of the nozzle lines. Instead, the third control piston 31 together with a third control valve serves a blow-off function.

The compressed air supplied via the compressed-air connection 21 is first conducted through a common flow section 33, and from there divided into the various flow branches. There is a flow connection from the common flow section 33, via a first flow branch, to the first nozzle line 3. The flow connection to the second nozzle line 5 and the third nozzle line 7 is provided via a common flow branch section 35, to which the second nozzle line 5 and the third nozzle line 7 are connected.

In order to open and block the flow connection to the second nozzle line 5 and third nozzle line 7 with the second control piston 25, the second control piston 25 is designed and configured to be able to penetrate into the common flow branch section 35 in order to thereby block or open the flow connection to the second nozzle line 5 and third nozzle line 7, in particular simultaneously.

For actuating the valve device 19, in particular the control valves, a control apparatus 37 is also provided which in this case is in particular in the form of a circuit board with an installed control logic. The circuit board is connected in terms of control to the first control valve 27, the second control valve 29, and the third control valve to transmit switching signals.

The control apparatus 37 is preferably connected to a control valve apparatus designed as a control valve module 38. This control valve module 38 is designed as a structural unit and in particular is reversibly separable from the adjacent structures, in particular other modules, of the vacuum generation device 1.

Optionally, an interface apparatus 39 can also have at least one signal connection 41 in order to contact the control apparatus 37 from outside—for example, for diagnostic and maintenance purposes and/or to feed in control signals from outside. The signal connection 41 is connected, in particular electrically, to the control apparatus 37 and/or directly to the control valves for signal transmission.

In this case, the control valves are in particular designed to actuate the control pistons pneumatically. This is done in particular by bringing one of the control valves into an open position upon actuation, wherein a flow path between a control line 43, which branches off from the common flow section 33, and the control piston is opened, whereby the pressure prevailing in the common flow section 33 acts upon the control piston, in particular an actuating end of the control piston, whereby the latter is displaced into its blocking position.

By additional actuation of one of the control valves, the control valve can then be brought into the blocking position, so that the control line is separated in terms of flow from the control piston. For resetting, a reset mechanism is preferably provided—for example, by means of a spring reset.

Alternatively, the control piston can be designed as a double-acting control piston so that, depending upon the position of the control valve, the control piston is pushed either into the blocking position or into the open position.

The flow path for compressed air through the vacuum generation device 1 begins at the compressed-air connection, from there passes through the common flow section 33, and from there divides into a flow branch leading to the first nozzle line 3 as well as a common flow branch section leading to the two other nozzle lines—in this case, the second nozzle line 5 and the third nozzle line 7. In the nozzle lines, the ejector nozzles are flowed through, starting with their drive nozzles 45. The introduced compressed air then flows through a particular central section 47 and a downstream diffuser 49, which opens into an interior space 51 of a silencer apparatus 53 designed as a module. In this case, each of the central sections 47 is preferably designed in a plurality of stages, in particular in three stages, so that, in the individual nozzle lines, a plurality of nozzle stages are provided in the form of a plurality of, in particular three, ejector nozzles.

A nozzle apparatus 55 which has the nozzle lines with the ejector nozzles, as well as a control piston apparatus 57 which has the control pistons, are also designed as a module.

Since the interface apparatus 39 is also designed as a module, in particular in the form of a cover, the vacuum generation device 1 consists overall of a plurality of, in particular five, modules, viz., the interface module, the control valve module 38, the control piston module 57, the nozzle module, and the silencer module. These modules are designed to be reversibly separable from one another, wherein plug-in connectors 59 are provided as fastening elements for fastening the modules to one another. Some of these plug-in connectors 59 are shown in particular in FIG. 3 and FIG. 4 with reference to the first embodiment, as well as in FIG. 5 with reference to the second embodiment, of the vacuum generation device 1. Each module has at least one plug-in connector 59 for each adjacent module in order to engage with a corresponding plug-in connector 59 of the adjacent module when the modules are clipped together.

In FIG. 2, the vacuum generation device 1 is depicted in a side view, wherein it can also be discerned here that the control pistons-here in particular the first control piston 23—can be actuated with control valves-here in particular the first control valve 27. The air entering the compressed-air connection 21 via the interface apparatus 39 designed as a module flows through the control valve module 38, the control piston apparatus 57 designed as a module, and the nozzle apparatus 55 designed as a module into the silencer apparatus 53 designed as a module. The air can escape from the silencer apparatus 53 to the outside via a flow opening 61.

Sound damping elements 63 are arranged in the silencer apparatus 53 and can, for example, comprise foam.

Preferably, between the silencer apparatus 53 and the nozzle apparatus 55, an extension module can be arranged, in particular is arranged, which has an additional nozzle stage and/or additional sound damping elements. This allows the vacuum generation device 1 to be flexibly expanded and adapted.

Furthermore, it is discernible in FIG. 2 that a fluid, in particular air, can be suctioned via a plurality of suction channels from an underside 65, designed as a suction side, of the vacuum generation device 1 or of the area suction gripper 18. In particular, three suction channels are provided. A first suction channel 67 leads from the underside 65 to a first section 69 of the central tract 47, and is preferably designed as a first ejector nozzle, has a small flow cross-section, and forms a first nozzle stage. A second suction channel 71 leads to a second, central section 73 of the central tract 47 and is preferably designed as a second ejector nozzle, has a medium flow cross-section, and forms a second nozzle stage. A third suction channel 75 leads to a third section 77 of the central tract 47 and is preferably designed as a third ejector nozzle, has a large flow cross-section, and forms a third nozzle stage. This makes the vacuum generation very effective, and a high vacuum can be generated.

The first suction channel 67, the second suction channel 71, and the third suction channel 75 extend from particular channel suction openings 79 to the nozzle lines, the first nozzle line 3 of which is depicted in FIG. 2.

In FIG. 3, in which the vacuum generation device 1 is seen from below so that the underside 65 faces the viewer, non-return valves 81 can also be seen, with which the channel suction openings 79 can be closed so that air can basically flow into the suction channels only from the outside, and an air flow from inside the vacuum generation device 1 to the outside is blocked by the non-return valves 81.

Also in FIG. 3 and FIG. 4, again, the guide surfaces 15, on which the vacuum generation device 1 is guided when inserted into the housing 17, can be discerned particularly well from below.

As can also be seen from FIG. 2, FIG. 3, and FIG. 4, each of the nozzle lines 3, 5, 7 is assigned not only three suction channels, but also, correspondingly, three channel suction openings 79 and three non-return valves 81, which hinders a backflow from the vacuum generation device 1 to the outside.

The housing 17, into which the vacuum generation device 1 can be inserted, has flow-permeable regions, in particular recesses, in the regions on which, in the inserted state, the channel suction openings 79 and the flow opening 61 of the silencer apparatus 53 are positioned.

Unlike in FIG. 3, the non-return valves 81 are not shown in FIG. 4, so that the view from below into the suction channels is clear.

Furthermore, it is discernible in FIG. 3 and FIG. 4 that the common flow section 33 is guided along the outside of the control valve module 38 as far as the control piston apparatus 39. This makes it clear in conjunction with FIG. 1 that the first nozzle line in FIG. 3 and FIG. 4 is arranged at the top, the second nozzle line 5 in the middle, and the third nozzle line 7 at the bottom.

FIG. 5 shows a vacuum generation device 1 according to a second embodiment, wherein the individual modules are each separated from one another. This means that the modules are not mounted on each other, and the plug-in connectors 59 do not engage with each other in the state shown here. This makes it easy to replace and maintain individual modules.

In this case as well, via a compressed-air connection 21, compressed air can be supplied, which then flows through a control valve apparatus 38 along a common flow section 33 and is thereby supplied to a control piston apparatus 57. If the control pistons arranged in the control piston apparatus 57 are in their open position, the compressed air flows additionally into the nozzle lines-here the first nozzle line 3, the second nozzle line 5, and the third nozzle line 7—wherein, here too, the second nozzle line 5 and third nozzle line 7 can preferably be closed and opened by means of the same control piston.

An extension module 83 which has an additional nozzle stage and/or additional sound damping elements is here connected in terms of flow downstream of the nozzle apparatus 55 with the in particular three nozzle lines.

The extension module 83 can have a plurality of sub-modules, wherein, in an end section 85, the air is diverted into an upper flow path with in this case in particular two upper flow lines 87, so that it flows back in the opposite direction to the flow direction in the nozzle lines, i.e., in the direction of the nozzle apparatus, and enters two further, upper flow lines 89 of the nozzle apparatus 55.

After flowing through the expansion module, the air is fed via the two further, upper flow lines 89 to an interface structure 91, to which the silencer apparatus 53 can preferably be connected in order to reduce the noise generation of the vacuum generation device 1.

In the second embodiment of the vacuum generation device 1 shown here, it is provided in particular that the silencer apparatus 53 be arranged outside the housing 17 into which the vacuum generation device 1 can be inserted, preferably by mounting the silencer apparatus 53 on the housing 17 from the outside.

FIG. 6 shows the second embodiment of the vacuum generation device 1 shown in FIG. 5, wherein the individual modules are here attached to one another.

1. A compressed-air-driven vacuum generation device for insertion into a housing of an area suction gripper, the compressed-air-driven vacuum generation device comprising:
a plurality of nozzle lines each having at least one ejector nozzle for generating a vacuum from compressed air,
at least one compressed-air connection for connection to a compressed-air supply, and
a valve device which is designed to individually open and/or close a particular flow connection between the nozzle lines and the at least one compressed-air connection.

2. The compressed-air-driven vacuum generation device according to claim 1, wherein the valve device is designed and configured to block and open a first nozzle line with a first closing element, and to block and open a second nozzle line and a third nozzle line together with a second closing element.

3. The compressed-air-driven vacuum generation device according to claim 1, wherein the valve device for opening and blocking the flow connection has at least one control piston which is arranged in a control piston apparatus, and which is designed and arranged to block the flow of at least one of the nozzle lines and to interrupt or at least weaken the flow connection to the ejector nozzle of this nozzle line.

4. The compressed-air-driven vacuum generation device according to claim 3, wherein the compressed-air-driven vacuum generation device for opening and blocking the flow connections has a control apparatus which is designed and configured to actuate the valve device-pneumatically and/or electrically.

5. The compressed-air-driven vacuum generation device according to claim 4, wherein a control valve apparatus is provided which is designed and configured to adjust the control piston, and has at least one electrically and/or pneumatically actuatable control valve.

6. The compressed-air-driven vacuum generation device according to claim 1, wherein the compressed-air-driven vacuum generation device has a suction channel which in terms of flow connects a channel suction opening to at least one of the nozzle lines.

7. The compressed-air-driven vacuum generation device according to claim 6, wherein the suction channel and the nozzle lines are arranged in a nozzle apparatus.

8. The compressed-air-driven vacuum generation device according to claim 6, wherein at least one non-return device or a non-return valve or a non-return flap is arranged in the suction channel in order to prevent a backflow from the nozzle line or a closed nozzle line, through the channel suction opening.

9. The compressed-air-driven vacuum generation device according to claim 1, wherein the compressed-air-driven vacuum generation device has a silencer apparatus, wherein the nozzle lines open into the silencer apparatus.

10. The compressed-air-driven vacuum generation device (1) according to claim 1, wherein the compressed-air-driven vacuum generation device has an interface apparatus designed as a front cover, wherein the compressed-air connection and/or at least one signal connection are arranged on the interface apparatus.

11. The compressed-air-driven vacuum generation device according to claim 1, wherein: the compressed-air-driven vacuum generation device has a suction channel which in terms of flow connects a channel suction opening to at least one of the nozzle lines, the suction channel and the nozzle lines are arranged in a nozzle apparatus, the compressed-air-driven vacuum generation device has a silencer apparatus, the nozzle lines open into the silencer apparatus, the nozzle apparatus, and/or the silencer apparatus are each designed as a module with its own module housing, and each have at least one fastening element or a plug-in connector, for mutually fastening the two apparatuses to one another.

12. The compressed-air-driven vacuum generation device according to claim 11, wherein, the nozzle apparatus, and/or the silencer apparatus are connected to one another in series.

13. An area suction gripper with the compressed-air-driven vacuum generation device according to claim 1 and with a housing into which the compressed-air-driven vacuum generation device is at least partially inserted, wherein the housing has a plurality of suction openings in one suction side.

14. The area suction gripper according to claim 13, wherein the compressed-air-driven vacuum generation device has a silencer apparatus, the nozzle lines open into the silencer apparatus, and the silencer apparatus is arranged completely in an interior space of the housing.
